(19) United States
(12) Patent Application Publication
(10) Pub. No.: US 2013/0294070 A1
(43) Pub. Date: Nov. 7, 2013

(54) HIGH BAY LIGHT

(71) Applicant: Chia-Tsung Tsao, Taipei (TW)

(72) Inventor: Chia-Tsung Tsao, Taipei (TW)

(21) Appl. No.: 13/463,221

(22) Filed: May 3, 2012

(51) Int. Cl. F21V 1/14; F21V 29/00; F21V 17/12; F21V 17/08; F21V 21/008

(52) U.S. Cl. 362/235

(57) ABSTRACT

A high bay light has a lamp holder, a light module, a plurality of cooling modules and a lamp cover. The lamp holder includes a frame. The frame has a plurality of connecting pieces extending radially therefrom. The light module is mounted on the lamp holder and includes a printed circuit board and at least one LED. The cooling modules are mounted on the printed circuit board and each cooling module includes a heat pipe and a cooling component. The lamp cover covers the cooling modules and includes an open bottom, an interior and a top hole. The open bottom and the top hole communicate with the interior. The connecting pieces of the frame are secured to the lamp cover so as to form a plurality of bottom holes between adjacent connecting pieces. With the above-mentioned structure, the high bay light can provide improved heat dissipation.

### BACKGROUND OF THE INVENTION

1. Field of the Invention

The present invention relates to a high bay light, and more particularly to a high bay light that uses a light emitting diode (LED) as a light source and provides improved heat dissipation.

2. Description of the Prior Arts

High bay lights are typically used for lighting in industrial buildings, warehouses and other large spaces that have high ceilings. More recently, the high bay lights use LEDs as light sources because LEDs are compact and energy efficient and have become increasingly popular.

LED performance depends on the temperature of the operating environment. Driving an LED in high ambient temperatures may cause overheating and device failure. Thus, providing a heat sink for dissipating heat from the LED is required to maintain long life of the LED.

A finned heat sink is presently the most widely used type of heat sink. The finned heat sink can absorb heat from the LED and then dissipate the heat into the surrounding air. However, the finned heat sink which transfers the heat only by heat conduction is slow and inefficient so that the heat dissipation can not be improved.

To overcome the shortcomings, the present invention provides a high bay light to mitigate or obviate the aforementioned problems.

### SUMMARY OF THE INVENTION

The main object of the present invention is to provide a high bay light to improve heat dissipation.

To achieve the foregoing objective, the high bay light in accordance with the present invention comprises a lamp holder, a light module, a plurality of cooling modules and a lamp cover. The lamp holder includes a frame. The frame has a top surface, a periphery, an aperture, and a plurality of connecting pieces. The connecting pieces extend radially from the periphery of the frame. The light module is mounted on the lamp holder and includes a printed circuit board (PCB) and at least one light emitting diode (LED). The PCB is secured to the top surface of the frame and has a top surface and a bottom surface. The at least one LED is mounted to the bottom surface of the PCB and is disposed within the aperture of the frame. The cooling modules are mounted on the PCB and each cooling module includes a heat pipe and a cooling component. The heat pipe has an evaporator portion and a condenser portion. The evaporator portion is secured to the top surface of the PCB. The condenser portion is connected to the cooling component. The lamp cover covers the cooling modules and includes an interior, an open bottom, a top hole and a bottom rim. The open bottom and the top hole communicate with the interior. The connecting pieces of the frame are secured to the bottom rim of the lamp cover so as to form a plurality of bottom holes between adjacent connecting pieces. Therefore, the heat from the LED is efficiently dissipated because the heat can be quickly transferred to the cooling components via the heat pipes. In addition, air can flow through the bottom holes into the interior of the lamp cover and flow out from the top hole of the lamp cover so as to enhance air convection, thereby providing improved heat dissipation.

Other objectives, advantages and novel features of the invention will become more apparent from the following detailed description when taken in conjunction with the accompanying drawings.

### BRIEF DESCRIPTION OF THE DRAWINGS

FIG. 1 is a bottom perspective view of a first embodiment of a high bay light in accordance with the present invention;

FIG. 2 is an exploded bottom perspective view of the first embodiment of the high bay light in FIG. 1;

FIG. 3 is an exploded top perspective view of the first embodiment of the high bay light in FIG. 1;

FIG. 4 is a side view in partial section of the first embodiment of the high bay light in FIG. 1;

FIG. 4A is a partial enlarged view of the first embodiment of the high bay light in FIG. 4;

FIG. 5 is an exploded top perspective view of a cooling module of the first embodiment of the high bay light in FIG. 1;

FIG. 6 is a bottom perspective view of a second embodiment of a high bay light in accordance with the present invention;

FIG. 7 is a bottom perspective view of a third embodiment of a high bay light in accordance with the present invention;

FIG. 8 is a bottom perspective view of a fourth embodiment of a high bay light in accordance with the present invention;

FIG. 9 is a side view in partial section of the fourth embodiment of the high bay light in FIG. 8; and

FIG. 10 is an exploded top perspective view of a cooling module of the fourth embodiment of the high bay light in FIG. 8.

### DETAILED DESCRIPTION OF THE PREFERRED EMBODIMENTS

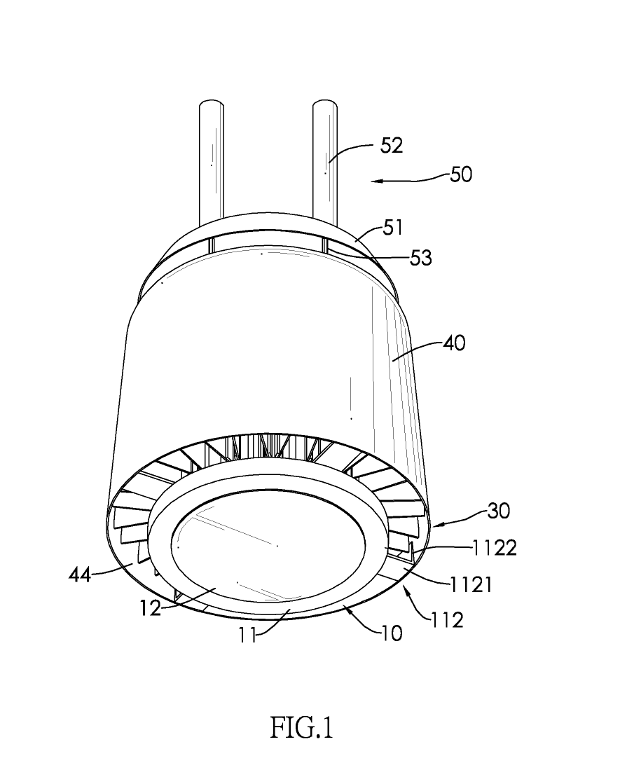

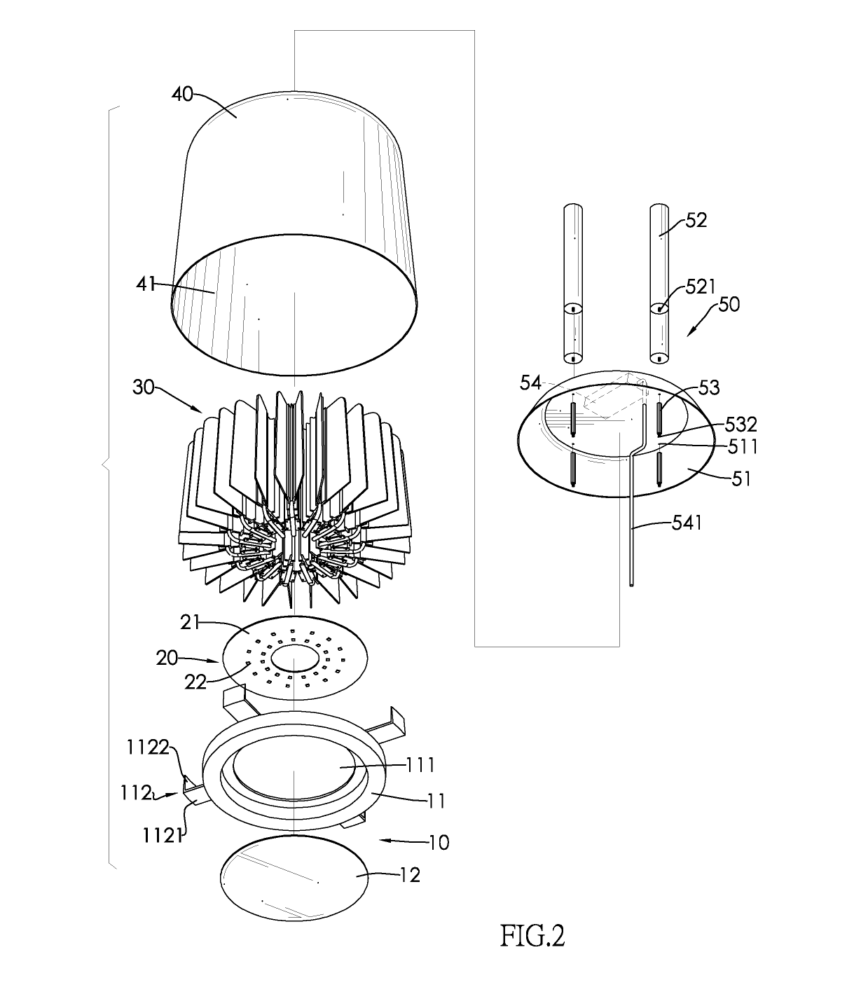

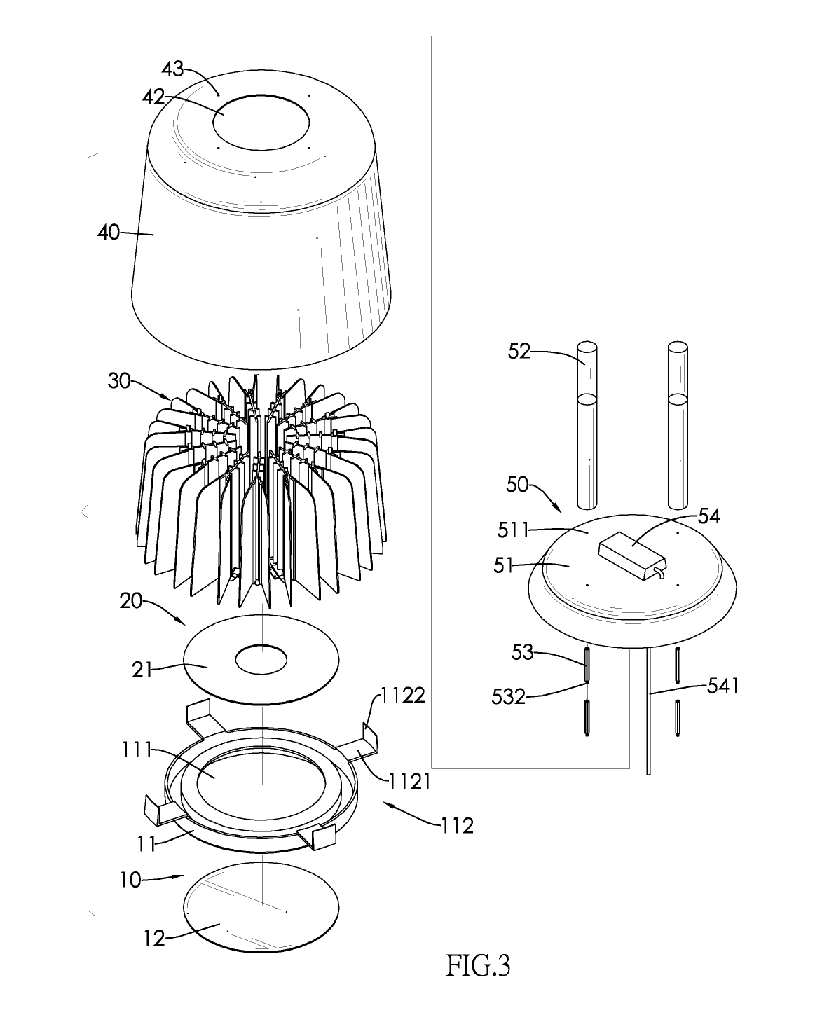

With reference to FIGS. 1 to 4A, a high bay light in accordance with the present invention comprises a lamp holder 10, a light module 20, a plurality of cooling modules 30, a lamp cover 40 and a hanging assembly 50.

The lamp holder 10 includes an annular frame 11 and a lens plate 12. The frame 11 has a top surface, a bottom surface, a center, a periphery, an aperture 111 and a plurality of connecting pieces 112. The aperture 111 is formed through the center of the frame 11. The connecting pieces 112 extend radially from the periphery of the frame 11 and each connecting piece 112 is bent to form a horizontal portion 1121 and an upward portion 1122. The lens plate 12 is secured to the bottom surface of the frame 11 and covers the aperture 111.

The light module 20 is mounted on the lamp holder 10 and includes a disk-shaped printed circuit board (PCB) 21 and at least one light emitting diode (LED) 22. The PCB 21 is secured to the top surface of the frame 11 and has a top surface, a bottom surface, a center and a periphery. The at least one LED 22 is mounted to the bottom surface of the PCB 21 and is disposed within the aperture 111 of the frame 11.

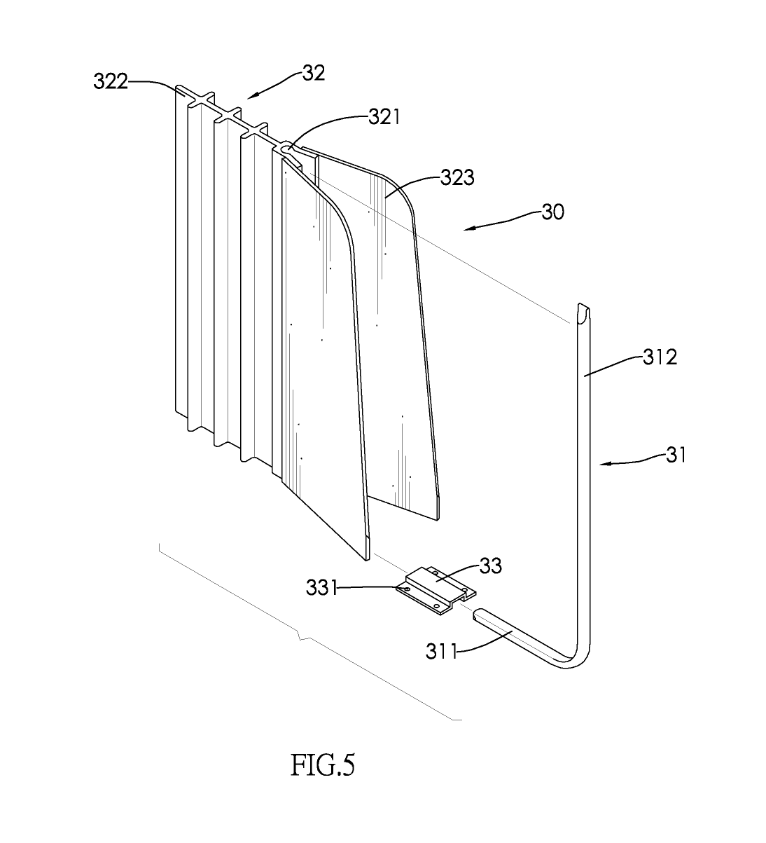

The cooling modules 30 are mounted on the PCB 21 and are arranged radially. With reference to FIG. 5, each cooling module 30 includes a heat pipe 31, a cooling component 32 and a fixed component 33. The heat pipe 31 is L-shaped and has a horizontal evaporator portion 311 and an upward condenser portion 312. The evaporator portion 311 is secured to the top surface of the PCB 21 by the fixed component 33 and has two ends. One of the ends of the evaporator portion 311 is connected to an end of the condenser portion 312 and is near the periphery of the PCB 21. The other end of the evaporator portion 311 is near the center of the PCB 21. The heat pipe 31 is filled with a working fluid and has a wick attached to an inner surface thereof. The heat pipe 31 is a heat-transfer device that has very high thermal conductivity. The cooling component 32 has a groove 321 formed therein for receiving the condenser portion 312 of the heat pipe 31.

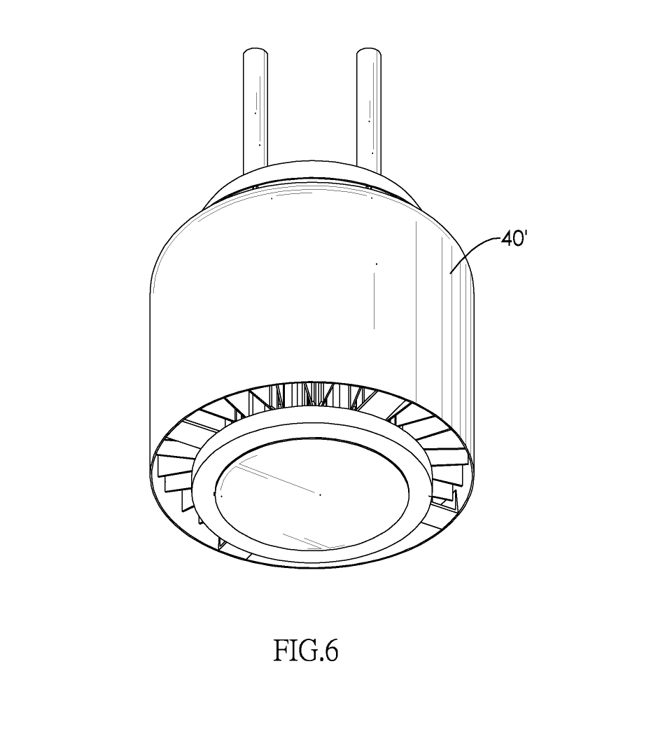

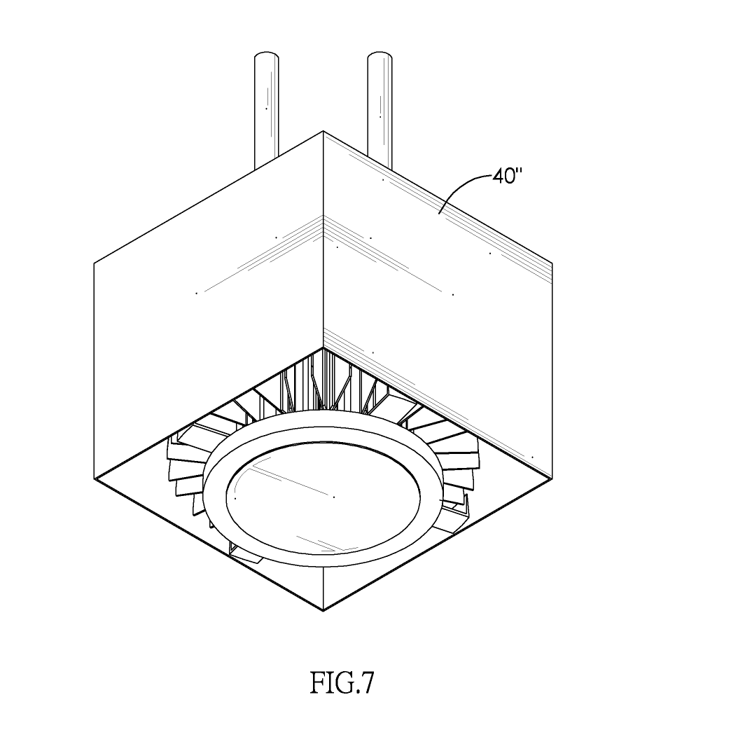

The lamp cover 40 covers the cooling modules 30 and includes a closed top, an open bottom, an interior 41, a top hole 42, a plurality of bores 43 and a bottom rim. The interior 41 receives the cooling modules 30. The top hole 42 is formed through a center of the closed top of the lamp cover 40. The bores 43 are respectively formed through the closed top of the lamp cover 40 around the top hole 42. The open bottom, the top hole 42 and the bores 43 communicate with the interior 41. The bottom rim has an inner surface to which the upward portions 1122 of the connecting pieces 112 of the frame 11 are secured so as to form a plurality of curved bottom holes 44 between adjacent connecting pieces 112. The lamp cover 40 may be truncated cone-shaped as shown or in other shapes, for example, the lamp cover 40′ may be cylinder-shaped as shown in FIG. 6 and the lamp cover 40″ may be rectangular prism-shaped as shown in FIG. 7.

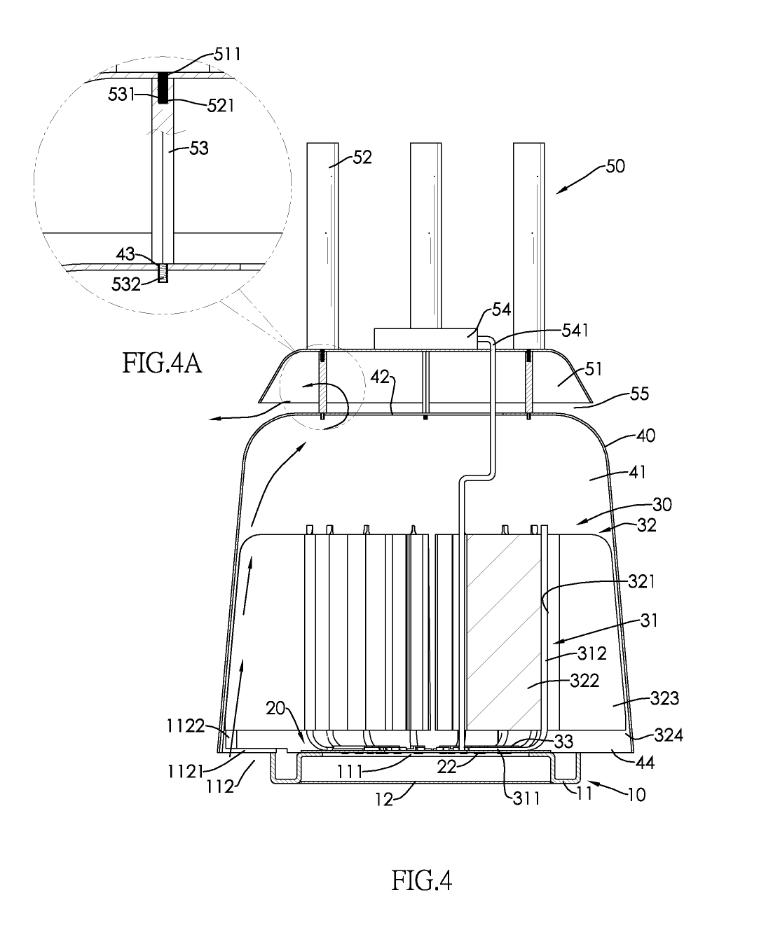

The hanging assembly 50 is mounted on the lamp cover 40 and includes a top cover 51, a plurality of hanging rods 52, a plurality of bolts 53 and a power supply 54. The top cover 51 is disposed above the lamp cover 40 to form a space 55 therebetween as shown in FIG. 4 for allowing the top hole 42 of the lamp cover 40 to communicate with outside. The top cover 51 has a top surface, a bottom surface and a plurality of bores 511. The bores 511 are formed through the top cover 51 in alignment with the bores 43 of the lamp cover 40. The number of the bores 511 of the top cover 51, the number of the hanging rods 52 and the number of the bolts 53 are respectively equal to the number of the bores 43 of the lamp cover 40. The hanging rods 52 are secured to the top cover 51 and each hanging rod 52 has a bottom end and a threaded portion 521. The threaded portion 521 extends from the bottom end of the hanging rod 52, passes through a corresponding bore 511 of the top cover 51 and protrudes from the bottom surface of the top cover 51. The bolts 53 are mounted between the lamp cover 40 and the top cover 51 and each bolt 53 has a top end, a bottom end, a threaded hole 531 and a threaded portion 532. The threaded hole 531 is formed in the top end of the bolt 53 and is screwed onto the threaded portion 521 of a corresponding hanging rod 52. The threaded portion 531 extends from the bottom end of the bolt 53 and is screwed into a corresponding bore 43 of the lamp cover 40. The power supply 54 is mounted on the top surface of the top cover 51 and has an output 541 connected to the PCB 21.

When the high bay light is in use, the evaporator portions 311 of the heat pipes 31 absorb the heat from the LED 22 and transfer the heat to the working fluid inside the heat pipes 31. The working fluid evaporates into vapor and flows to the condenser portions 312. The condenser portions 312 transfer the heat to the cooling components 32 and the cooling components 32 then dissipate the heat. The vapor condenses into droplets when transferring the heat to the cooling component 32 and the condensed water flows back to the evaporator portion 311 due to capillary force exerted by the wick. Therefore, the heat from the LED 22 is efficiently dissipated because the heat can be quickly transferred to the cooling components 32 via the heat pipes 31. In addition, air can flow through the bottom holes 44 into the interior 41 of the lamp cover 40 and flow out from the top hole 42 and the space 55 so as to enhance air convection, thereby providing improved heat dissipation.

With reference to FIG. 5, in a preferred embodiment of the cooling module 30 according to the present invention, the cooling component 32 is Y-shaped in cross section and has a connecting part 322 and two symmetrical fins 323. The connecting part 322 has an inner edge, an outer edge and the groove 321. The inner edge of the connecting part 322 is near the center of the PCB 21. The outer edge of the connecting part 322 is near the periphery of the PCB 21. The groove 321 is formed in the outer edge of the connecting part 322. Each fin 323 has an inner edge and an outer edge. The inner edge of the fin 323 is connected to the outer edge of the connecting part 322. The outer edge of the fin 323 is adjacent to the lamp cover 40 so that a gap 324 is formed therebetween as shown in FIG. 4 for allowing air flow therethrough. The evaporator portion 311 of the heat pipe 31 is flattened and abuts against the top surface of the PCB 21. The fixed component 33 is a panel, is cross mounted on the evaporator portion 311 of the heat pipe 31 and has a plurality of fastening holes 331 formed in two sides thereof. Fasteners are respectively mounted in the fastening holes 331 of the fixed component 33 and the PCB 21 so as to secure the heat pipe 31 on the PCB 21.

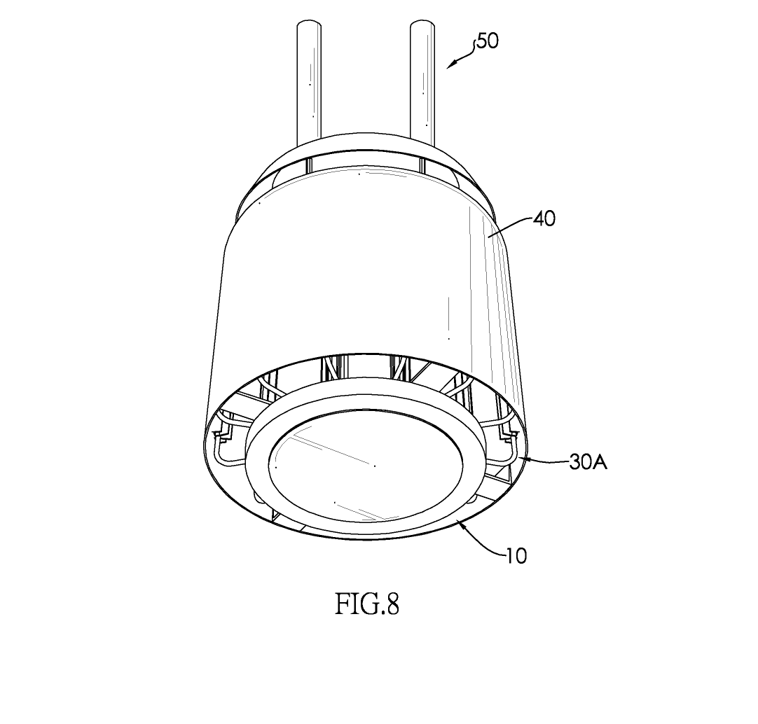

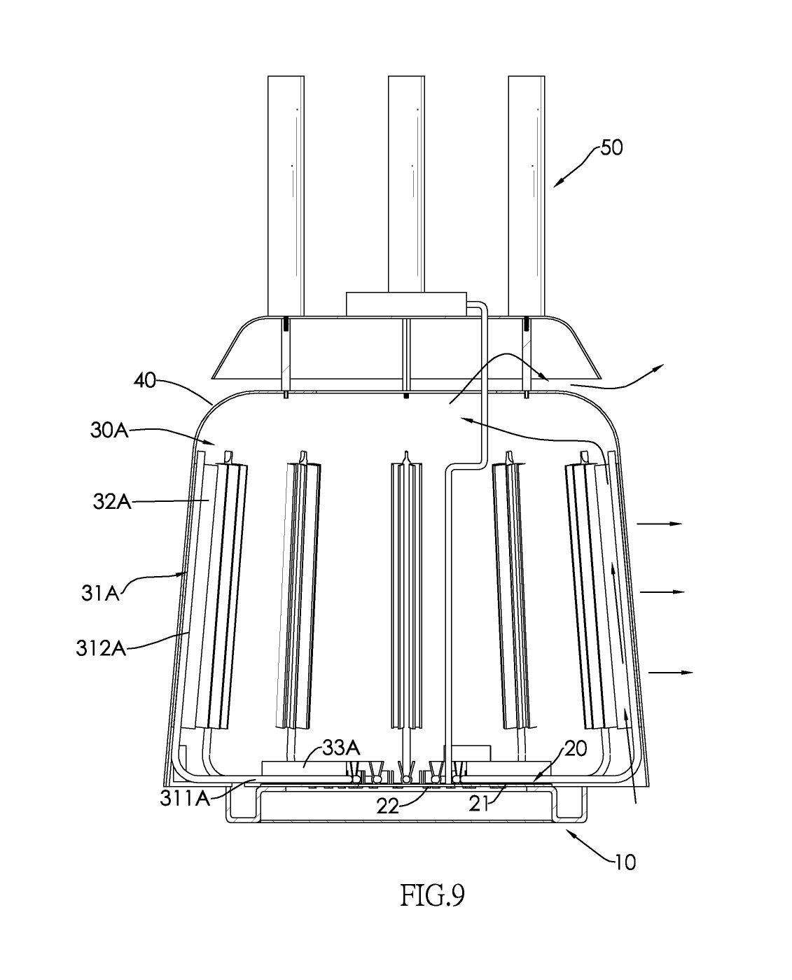

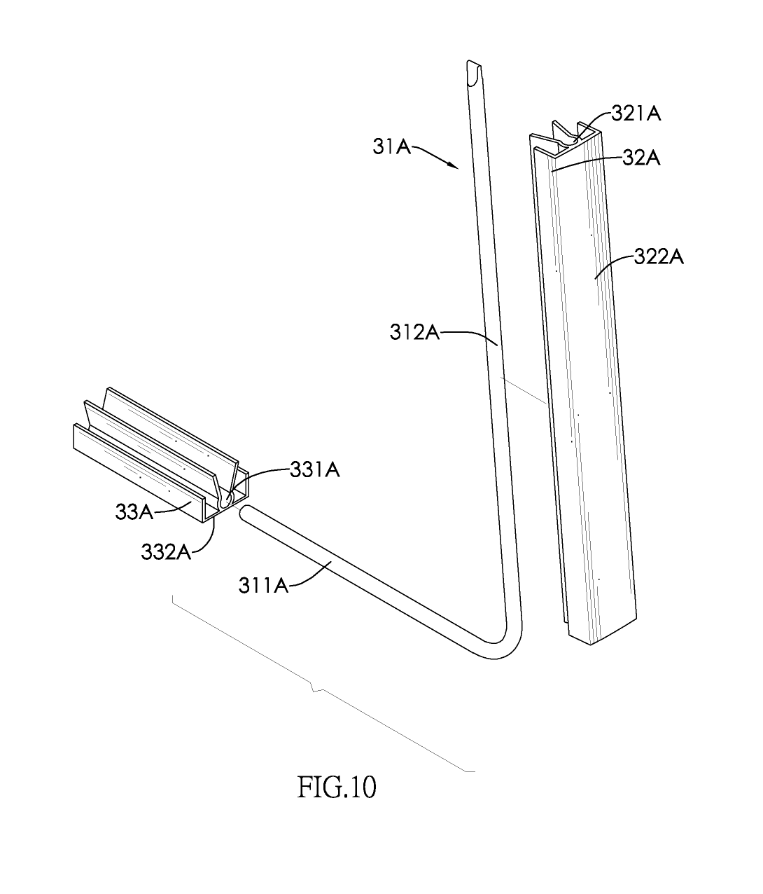

With reference FIGS. 8 to 10, in another preferred embodiment of the cooling module 30A according to the present invention, the cooling component 32A is an elongated block and has an inner surface, a flat outer surface 322A and the groove 321A. The groove 321A is formed in the inner surface of the cooling component 32A. The flat outer surface 322A abuts and is attached to the lamp cover 40. The fixed component 33A is an elongated cooling block and has a top surface, a flat bottom surface 332A and a groove 331A. The groove 331A is formed in the top surface of the fixed component 33A for receiving the evaporator portion 311A of the heat pipe 31A. The flat bottom surface 332A abuts and is attached to the top surface of the PCB 21 so as to secure the heat pipe 31A on the PCB 21. In this embodiment, the heat from the LED 22 can be transferred to the lamp cover 40 via the cooling component 32A and dissipated by the lamp cover 40. Thus, the heat dissipation can be further improved.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A high bay light comprising:
a lamp holder including a frame having:
a top surface;
a periphery;
an aperture; and
a plurality of connecting pieces extending radially from the periphery of the frame;
a light module mounted on the lamp holder and including:
a printed circuit board secured to the top surface of the frame and having a top surface and a bottom surface; and
at least one LED mounted to the bottom surface of the printed circuit board and disposed within the aperture of the frame;
a plurality of cooling modules mounted on the printed circuit board and each cooling module including:
a heat pipe having:
an evaporator portion secured to the top surface of the printed circuit board; and
a condenser portion; and
a cooling component connected to the condenser portion of the heat pipe;
a lamp cover covering the cooling modules and including:
an interior;
a closed top;
an open bottom communicating with the interior of the lamp cover;
a top hole formed through the closed top of the lamp cover and communicating with the interior of the lamp cover; and
a bottom rim to which the connecting pieces of the frame are secured so as to form a plurality of bottom holes between adjacent connecting pieces; and
a hanging assembly mounted on the lamp cover and including:
a top cover disposed above the lamp cover to form a space therebetween for allowing the top hole of the lamp cover to communicate with outside;
a plurality of hanging rods secured to the top cover; and
a power supply mounted on the top cover and having an output connected to the printed circuit board.

2. The high bay light as claimed in claim 1, wherein
each connecting piece of the frame is bent to form a horizontal portion and an upward portion; and
the bottom rim of the lamp cover has an inner surface to which the upward portions of the connecting pieces of the frame are secured.

3. The high bay light as claimed in claim 1, wherein
the lamp cover includes a plurality of bores formed through the closed top thereof;
the top cover has a plurality of bores formed therethrough in alignment with the bores of the lamp cover;
each hanging rod has
a bottom end; and
a threaded portion extending from the bottom end of the hanging rod, passing through a corresponding bore of the top cover and protruding from a bottom surface of the top cover; and
the hanging assembly further includes a plurality of bolts mounted between the lamp cover and the top cover and each bolt has
a top end;
a bottom end;
a threaded hole formed in the top end of the bolt and screwed onto the threaded portion of a corresponding hanging rod; and
a threaded portion extending from the bottom end of the bolt and screwed into a corresponding bore of the lamp cover.

4. The high bay light as claimed in claim 2, wherein
the lamp cover includes a plurality of bores formed through the closed top thereof;
the top cover has a plurality of bores formed therethrough in alignment with the bores of the lamp cover;
each hanging rod has
a bottom end; and
a threaded portion extending from the bottom end of the hanging rod, passing through a corresponding bore of the top cover and protruding from a bottom surface of the top cover; and
the hanging assembly further includes a plurality of bolts mounted between the lamp cover and the top cover and each bolt has
a top end;
a bottom end;
a threaded hole formed in the top end of the bolt and screwed onto the threaded portion of a corresponding hanging rod; and
a threaded portion extending from the bottom end of the bolt and screwed into a corresponding bore of the lamp cover.

5. The high bay light as claimed in claim 1, wherein
the heat pipe is L-shaped and the condenser portion thereof is upward; and
the cooling component has a groove formed therein for receiving the condenser portion of the heat pipe.

6. The high bay light as claimed in claim 2, wherein
the heat pipe is L-shaped and the condenser portion thereof is upward; and
the cooling component has a groove formed therein for receiving the condenser portion of the heat pipe.

7. The high bay light as claimed in claim 3, wherein
the heat pipe is L-shaped and the condenser portion thereof is upward; and
the cooling component has a groove formed therein for receiving the condenser portion of the heat pipe.

8. The high bay light as claimed in claim 4, wherein
the heat pipe is L-shaped and the condenser portion thereof is upward; and
the cooling component has a groove formed therein for receiving the condenser portion of the heat pipe.

9. The high bay light as claimed in claim 5, wherein
the evaporator portion of the heat pipe is horizontal; and
each cooling module further includes a fixed component and the evaporator portion of the heat pipe is secured to the printed circuit board by the fixed component.

10. The high bay light as claimed in claim 6, wherein
the evaporator portion of the heat pipe is horizontal; and
each cooling module further includes a fixed component and the evaporator portion of the heat pipe is secured to the printed circuit board by the fixed component.

11. The high bay light as claimed in claim 7, wherein
the evaporator portion of the heat pipe is horizontal; and
each cooling module further includes a fixed component and the evaporator portion of the heat pipe is secured to the printed circuit board by the fixed component.

12. The high bay light as claimed in claim 8, wherein
the evaporator portion of the heat pipe is horizontal; and
each cooling module further includes a fixed component and the evaporator portion of the heat pipe is secured to the printed circuit board by the fixed component.

13. The high bay light as claimed in claim 9, wherein the cooling component is Y-shaped in cross section and has
a connecting part having:
an inner edge being near a center of the printed circuit board;
an outer edge being near a periphery of the printed circuit board; and
the groove formed in the outer edge of the connecting part; and
two symmetrical fins and each fin having:
an inner edge connected to the outer edge of the connecting part; and
an outer edge being adjacent to the lamp cover so that a gap is formed therebetween.

14. The high bay light as claimed in claim 10, wherein the cooling component is Y-shaped in cross section and has
a connecting part having:
an inner edge being near a center of the printed circuit board;
an outer edge being near a periphery of the printed circuit board; and
the groove formed in the outer edge of the connecting part; and
two symmetrical fins and each fin having:
an inner edge connected to the outer edge of the connecting part; and
an outer edge being adjacent to the lamp cover so that a gap is formed therebetween.

15. The high bay light as claimed in claim 13, wherein
the evaporator portion of the heat pipe is flattened and abuts against the top surface of the printed circuit board; and
the fixed component is a panel, is cross mounted on the evaporator portion of the heat pipe and has a plurality of fastening holes formed in two sides thereof, and fasteners are respectively mounted in the fastening holes of the fixed component and the printed circuit board.

16. The high bay light as claimed in claim 14, wherein
the evaporator portion of the heat pipe is flattened and abuts against the top surface of the printed circuit board; and
the fixed component is a panel, is cross mounted on the evaporator portion of the heat pipe and has a plurality of fastening holes formed in two sides thereof, and fasteners are respectively mounted in the fastening holes of the fixed component and the printed circuit board.

17. The high bay light as claimed in claim 9, wherein the cooling component is a block and has
an inner surface;
a flat outer surface abutting and attached to the lamp cover; and
the groove formed in the inner surface of the cooling component.

18. The high bay light as claimed in claim 10, wherein the cooling component is a block and has
an inner surface;
a flat outer surface abutting and attached to the lamp cover; and
the groove formed in the inner surface of the cooling component.

19. The high bay light as claimed in claim 17, wherein the fixed component is an elongated cooling block and has
a top surface;
a flat bottom surface abutting and attached to the top surface of the printed circuit board; and
a groove formed in the top surface of the fixed component for receiving the evaporator portion of the heat pipe.

20. The high bay light as claimed in claim 18, wherein the fixed component is an elongated cooling block and has
a top surface;
a flat bottom surface abutting and attached to the top surface of the printed circuit board; and
a groove formed in the top surface of the fixed component for receiving the evaporator portion of the heat pipe.
